(19) United States
(12) Patent Application Publication
(10) Pub. No.: US 2026/0342813 A1
(43) Pub. Date: Oct. 29, 2026

(54) BLAST RADIUS GRAPH DRIVEN DYNAMIC DETECTION RULES FOR THREAT EVENT DETECTION IN LIVE CLOUD ENVIRONMENT

(71) Applicant: Palo Alto Networks, Inc., Santa Clara, CA (US)

(72) Inventors: Alok Tongaonkar, San Jose, CA (US); Sathya Prakash Rajagopal, San Jose, CA (US); Ruben Dario Torres Guerra, Menlo Park, CA (US); Ajaya Neupane, San Jose, CA (US)

(21) Appl. No.: 19/192,720

(22) Filed: Apr. 29, 2025

(51) Int. Cl. H04L 9/40

(52) U.S. Cl. CPC H04L 63/1416

(57) ABSTRACT

A threat detection system constructs a blast radius graph, periodically updates the blast radius graph, and trains and retrains a graph embedding model on the blast radius graph. The threat detection system extracts attack paths to crown jewels from the blast radius graph, generates graph embeddings from the extracted attack paths, and updates a graph embeddings database. With the database of attack path graph embeddings, a cloud environment is monitored for events and graphs constructed from correlated events. Graph embeddings are generated from the graphs and evaluated against the attack path graph embeddings.

### BACKGROUND

The disclosure generally relates to cybersecurity in a cloud environment (e.g., CPC subclass H04L 63).

Malicious actors use tactics including lateral movement and privilege escalation to access critical assets of an organization. These critical assets are often referred to as crown jewels. A critical asset can be sensitive data or a critical system or system component. These tactics leverage a sequence of misconfigurations and/or vulnerabilities of a cloud environment. These sequences are referred to as attack paths. Blast radius graphs can be constructed to visually present or logically encode these attack paths to crown jewels.

### BRIEF DESCRIPTION OF THE DRAWINGS

Embodiments of the disclosure may be better understood by referencing the accompanying drawings.

FIG. 1 is a diagram of a threat detection system that detects real-time attacks on crown jewel assets based on graph embeddings of potential attack paths to the crown jewel assets of an organization.

FIG. 2 is a flowchart of example operations for building blast radius graphs and maintaining graph embeddings for dynamic security policy enforcement.

FIG. 3 is a flowchart of example operations for obtaining identifiers of cloud-based resources with crown jewel assets and building an organization blast radius graph from crown jewel assets to principals based on attack path heuristics.

FIG. 4 is a flowchart of example operations for monitoring events in a cloud environment with respect to attack path graph embeddings-based security rules.

FIG. 5 depicts an example computer system with components of a threat detection system that detects threats based on attack path graph embeddings.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The description uses the term “principal” as used in a cloud computing context. A principal is any entity that can be authenticated and authorized to interact with cloud resources according to a granted permission. A principal can be a user, process/service, service account, or application.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

A threat detection system has been developed that uses graph embeddings to generate dynamic and flexible security rules for monitoring a cloud environment to detect threats against crown jewels of an organization. The threat detection system constructs a blast radius graph, periodically updates the blast radius graph, and trains and retrains a graph embedding model on the blast radius graph. The threat detection system extracts attack paths to crown jewels from the blast radius graph, generates graph embeddings from the extracted attack paths, and updates a graph embeddings database. With the database of attack path graph embeddings, a cloud environment is monitored for events and graphs constructed from correlated events. Graph embeddings are generated from the graphs and evaluated against the attack path graph embeddings. The graph embeddings are the basis for the security rules as similarity with an attack path graph embedding is an indication of a threat. Use of embeddings allows the security rules to be flexible by detecting similar paths instead of being constrained to a strict attack path matching. In addition, the security rules are dynamic because of the ongoing updates to the blast radius graph and attack path graph embeddings database.

### Example Illustrations

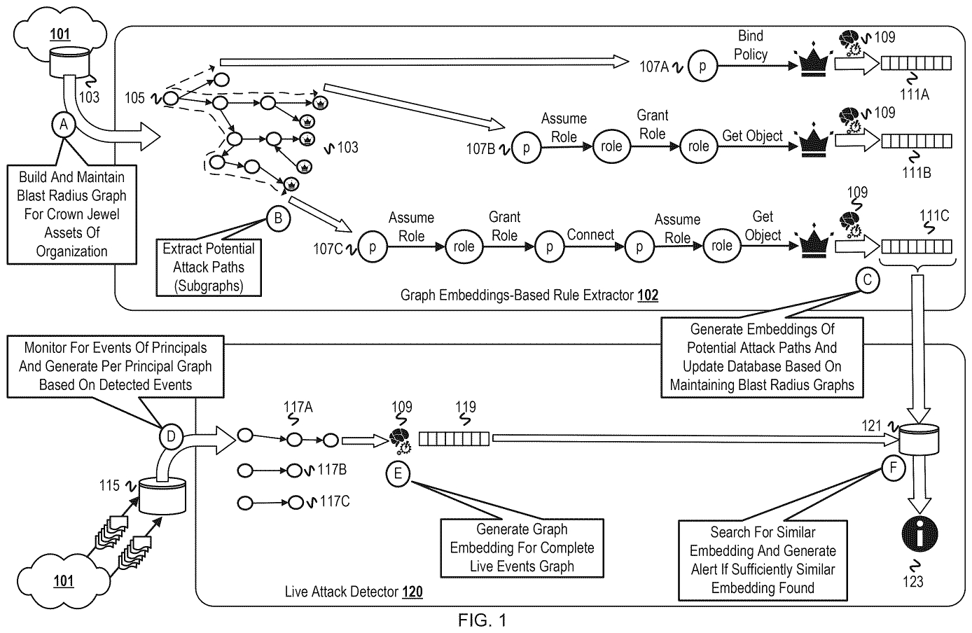

FIG. 1 is a diagram of a threat detection system that detects real-time attacks on crown jewel assets based on graph embeddings of potential attack paths to the crown jewel assets of an organization. FIG. 1 depicts the threat detection system as including a graph embeddings-based rule extractor (“rule extractor”) 102 and a live attack detector 120. The rule extractor 102 builds and maintains blast radius graphs for crown jewel assets of an organization based on data of a cloud environment 101 of the organization. The live attack detector 120 monitors live events in the cloud environment based on graph embeddings-based rules extracted by the rule extractor 102.

FIG. 1 is annotated with a series of letters A-F representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the rule extractor 102 builds and maintains blast radius graphs for crown jewel assets of the organization. Maintaining blast radius graphs can be rebuilding blast radius graphs periodically and/or responsive to a change event (e.g., new principal or asset) or updating previously built blast radius graphs. FIG. 1 depicts a blast radius graph 103 that represents a blast radius graph from a single principal represented by node 105 to multiple crown jewel assets. The rule extractor 102 builds the blast radius graph 103 based on attack path heuristics that specify the various roles, permissions, and entities that can form an attack path. Embodiments may build a blast radius graph for an organization and decompose the organization blast radius graph into principal granularity blast radius graphs or build each principal granularity blast radius graph.

At stage B, the rule extractor 102 extracts potential attack paths or subgraphs from the blast radius graph 103. Since the rule extractor built the blast radius graph 103 based on the attack path heuristics, each path to a crown jewel asset is a potential attack path. FIG. 1 depicts potential attack paths 107A-107C extracted from the blast radius graph 103. Each of the potential attack paths 107A-107C begins with the principal node 105 and ends with a crown jewel asset node. The potential attack path 107A includes a single edge labeled “Bind Policy” that connects the node 105 to a crown jewel asset node. The potential attack path 107B includes multiple intermediary nodes and permission edges between the node 105 and a crown jewel asset node. In the potential attack path 107B, the principal node 105 is connected to a “role” node by an edge labeled “Assume Role.” The “role” node is connected to a second “role” node by an edge labeled “Grant Role.” The second “role” node is connected to the crown jewel asset node with an edge labeled “Get Object.” The potential attack path 107C also includes multiple intermediary nodes and permission edges between the node 105 and a crown jewel asset node. In the potential attack path 107C, the principal node 105 is connected to a “role” node by an edge labeled “Assume Role.” This first “role” node of the potential attack path 107C is connected to a second principal node by an edge labeled “Grant Role.” The second principal node is connected to a third principal node by an edge labeled “Connect.” The third principal node connects by an edge labeled “Assume Role” to a second “role” node which connects to the crown jewel asset node by an edge labeled “Get Object.”

At stage C, the rule extractor 102 generates graph embeddings of the potential attack paths and updates a database 121 of graph embeddings. The rule extractor 102 invokes a graph embedding model 109 on each extracted potential attack path to generate a corresponding graph embedding. The graph embedding model 109 was previously trained on the blast radius graph 103 (or a larger blast radius graph that includes the blast radius graph 103). As the graph embeddings represent potential attack paths, the effective security rule is that a path or graph of live events that is sufficiently similar based on a distance metric to any one of the graph embeddings in the database 121 is not permitted or triggers a security action, such as an alert, because it is indication of a threat or attack. The rule extractor 102 ensures the rules are dynamic and current by maintaining the database 121 of embeddings with the graph embeddings generated after each update or rebuild of blast radius graphs.

At stage D, the live attack detector 120 monitors events in the cloud environment 101 that are recorded into a repository 115 of cloud environment events. The live attack detector 120 likely monitors multiple repositories or logs of cloud environment events, but a single repository is depicted to avoid obfuscating the disclosure. The live attack detector 120 monitors for events of principals (e.g., user, service or process that can have a role or perform an action). When the live attack detector 120 detects an event of a principal, the live attack detector 120 builds a graph of the corresponding events. For instance, the live attack detector 120 creates a node to represent a user and a node representing a compute instance, and then connects the nodes with an edge labeled with an action taken to instantiate the compute instance. For each principal with a detected event, the live attack detector 120 will continue building a graph until complete. The live attack detector 120 determines that a graph is complete when reaching a halt condition or reaching a resource that qualifies as critical, such as a database or repository that can host sensitive data. FIG. 1 depicts that the live attack detector 120 has built 3 graphs 117A-117C. Assuming a halt condition of three nodes, the graph 117A is complete.

At stage E, the live attack detector 120 generates a graph embedding 119 for the graph 117A, which is a complete live events graph. The live attack detector 120 invokes the graph embedding model 109 to generate the graph embedding 119.

At stage F, the live attack detector 120 searches the embeddings database 121 for a most similar graph embedding with respect to the graph embedding 119. Sufficiently similar can be determined against a predefined/configurable similarity threshold. If a graph embedding is found in the database 121 that is sufficiently similar to the graph embedding 119, then an alert 123 is generated. A security action can then be taken to prevent the threat seemingly posed by the principal corresponding to the graph 117A.

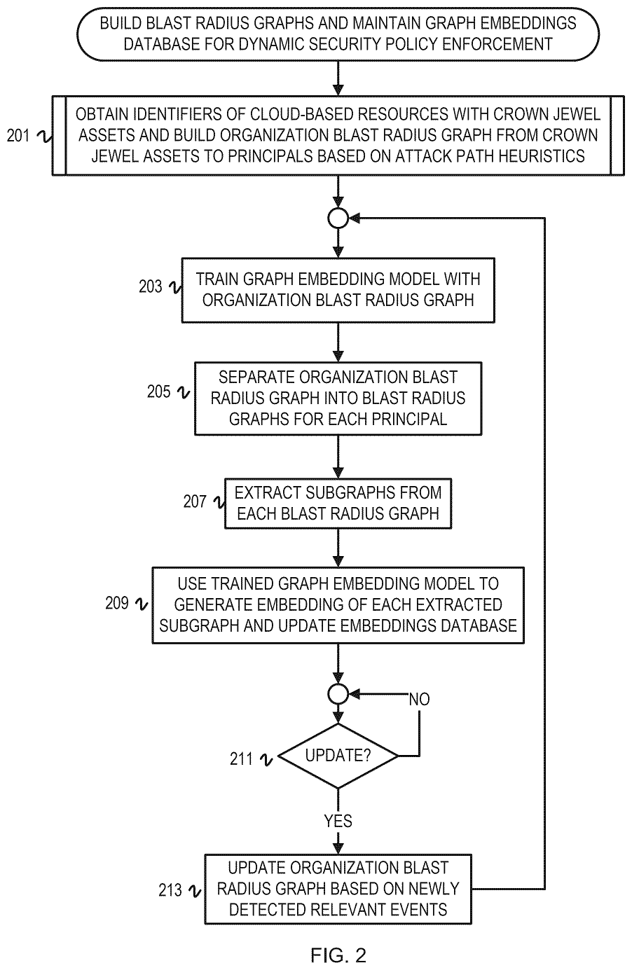

FIGS. 2-4 are flowcharts of example operations for deriving dynamic and flexible threat detection security rules for crown jewel assets and monitoring a cloud environment with the derived security rules. The example operations are described with reference to a threat detection system for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for building blast radius graphs and maintaining graph embeddings for dynamic security policy enforcement. A threat detection system will build an initial blast radius graph and update the graph over time to adapt to changes in a cloud environment and changes in attack path heuristics. The threat detection system can start monitoring the cloud environment with the initially generated attack path graph embeddings and concurrently maintain current blast radius graphs that can cause updates to the attack path graph embeddings.

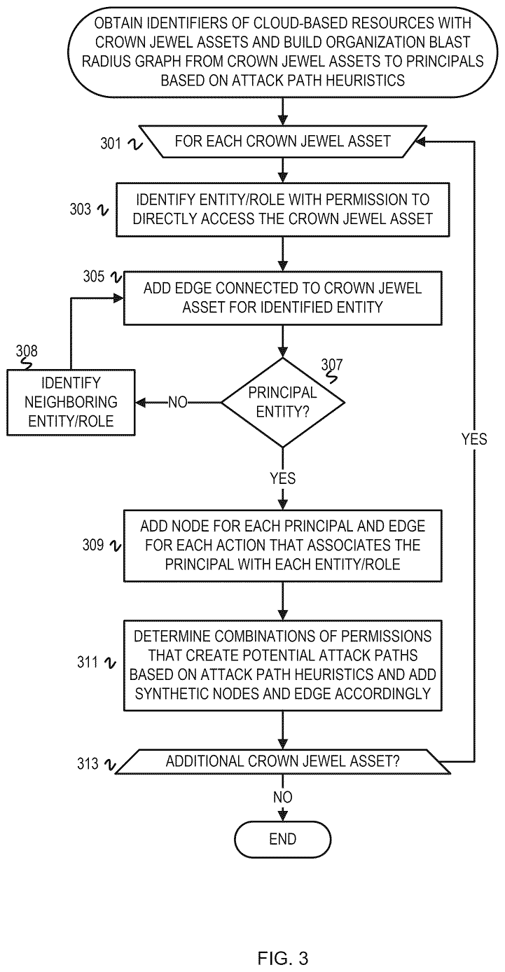

At block 201, the threat detection system obtains identifiers of cloud-based resources with crown jewel assets and builds an organization blast radius graph from crown jewel assets to principals based on attack path heuristics. Identifiers of crown jewel assets can be provided in a file, in user interface events, and/or application programming interface (API) requests. The identifiers are resource identifiers, such as a storage identifier, endpoint identifier, or database identifier. The resource itself may be a critical/sensitive asset or be considered a critical/sensitive asset because of content hosted in the resource. FIG. 2 refers to building an organization blast radius graph because it presumes that the threat detection system will build a graph with paths from multiple principals to the identified crown jewel assets before decomposing into principal specific blast radius graphs. Embodiments can instead build the principal specific blast radius graphs without decomposing a supergraph. Example operations for block 201 are presented in FIG. 3.

At block 203, the threat detection system trains a graph embedding model with the organization blast radius graph. Functions defined in a library that implement an algorithm for learning distributed representations of graphs are invoked with indication of the organization blast radius graph to train the embedding model. An example of a graph learning algorithm is graph2vec.

At block 205, the threat detection system separates the organization blast radius graph into blast radius graphs for each principal. The threat detection extracts (e.g., traces and copies) all paths from each source node of the organization blast radius graph to the crown jewel assets as a principal specific blast radius graph. This can be considered a pre-processing step before embedding generation to obtain graph embeddings corresponding to individual principal based potential attack paths. The graph embeddings correspond to individual principals at least partly because the threat detection system will monitor the cloud environment for events that originate from a principal.

At block 207, the threat detection system extracts potential attack paths or subgraphs from each principal-based blast radius graph. Extraction of the subgraph has some flexibility as detection is based on embedding similarity and not exact path matching or pattern matching. As an example of the flexibility in subgraph extraction, the threat detection system can randomly extract subgraphs from each principal-based blast radius graph, extract all possible paths, or extract each potential attack path from source node to reachable crown jewel asset node. The threat detection system can examine each principal-based blast radius graph against risk characteristics (e.g. an expired token) and extract a subgraph around each entity characterized as risky with respect to the risk characteristics. To illustrate, a compute instance without a most recent version of the Cloud Instance Metadata Service (IMDS) enabled is detected. A subgraph corresponding to a blast radius path could be extracted that includes user→compute instance with run instance permission→compute instance→pass role permission→admin role with get object permission→store.

At block 209, the threat detection system uses the trained graph embedding model to an generate embedding of each extracted subgraph. With the trained graph embedding model, the threat detection system can invoke an API defined or library defined function to generate an embedding for each extracted path or subgraph. The threat detection system then updates a vector (embeddings) database with the generated graph embeddings (“potential attack path graph embeddings”).

At block 211, the threat detection system determines whether a criterion for updating blast radius graphs is satisfied. The update criterion can be time-based and/or event based. For example, an update criterion may be expiration of a configured time period (e.g., every 2 hours). As another example, an update criterion can be detection of one or more change events (e.g., addition of a type of asset or entity or amount of changes to permissions or role assignments). If the update criterion is satisfied, then operational flow proceeds to block 213. Otherwise, operational flow returns to block 211, perhaps after a waiting period.

At block 213, the threat detection system updates the organization blast radius graph based on newly detected relevant events. After the update criterion is satisfied, the threat detection system can evaluate a changelog listing of change events for the cloud environment to identify those that are relevant. Relevancy is determined with respect to the attack path heuristics. The attack path heuristics have been determined for various attack tactics, such as lateral movement and privilege escalation in a cloud environment. The information can be determined from security incident reports and/or security analyst team reports. Attack path heuristics can indicate an action, such as granting of a role or change in permission, that can occur in a potential attack path. The attack path heuristics can specify relevant entities and combinations of actions and relevant entities, such as a combination of a compute instance being instantiated and assuming a role. The attack path heuristics will be derived from real-world attacks that are bound to specific cloud service providers (CSPs). However, CSP agnostic heuristics can be extrapolated from the CSP specific heuristics and mapped to CSP specific heuristics. Examples of permissions and actions indicated in the attach path heuristics include those that relate to role assignments, instantiation, object retrieval, asset connection, function invocation, policy attachment, and key management. The attack path heuristics will also specify combinations of configurations, permissions and/or actions that create vulnerabilities or correspond to attack tactics when chained together. These combinations are likely not explicitly defined in Identity and Access Management systems. Generally, a toxic combination will allow an action or permission for an entity without a corresponding command.

FIG. 3 is a flowchart of example operations for obtaining identifiers of cloud-based resources with crown jewel assets and building an organization blast radius graph from crown jewel assets to principals based on attack path heuristics. As stated earlier, embodiments may build the principal-based blast radius graphs directly from the cloud environment data instead of decomposing an organization level blast radius graph. For instance, multiple blast radius graphs can be under construction as the threat detection system builds path in reverse from the crown jewel assets to principals. However, the example operations of FIG. 3 presume an organization level construction before decomposing into individual principal-based blast radius graphs.

At block 301, the threat detection system begins building paths in reverse from each crown jewel asset towards one or more sources. Since criticality and sensitivity of an asset can vary by organization, the organization will identify which assets are crown jewel assets. Thus, the graph building can commence after obtaining the list of identifiers or when a threshold number of identifiers have been received. A crown jewel asset of a current iteration will be referred to as a selected crown jewel asset.

At block 303, the threat detection system identifies an entity/role with permission to directly access the crown jewel asset. An entity may be principal, role or an asset that is not a crown jewel asset. The attack path heuristics will indicate which permissions and roles can be implicated in an attack. The threat detection system can read configurations corresponding to the crown jewel asset to identify the entities with those permissions or roles. The attack path heuristics may indicate cloud environment specific labels for the permissions or roles, or the threat detection system can use a mapping of generic permission and role labels to cloud environment specific labels.

At block 305, the threat detection system adds an edge connected to a node which represents the currently selected crown jewel asset for the identified entity. The threat detection system will add a node for the identified entity and connect that node with the edge. The node will be decorated or encoded with descriptors for the entity, such as entity type and entity name. The edge will be labeled with the permission or role.

At block 307, the threat detection system determines whether an identified entity is a principal. A principal can be a source or an intermediary in a potential attack path. The role of the principal will be inferred from the graph structure as represented by the graph embeddings and event context. If the entity is a principal, then operational flow proceeds to block 309. Otherwise, operational flow proceeds to block 308.

At block 308, the threat detection system identifies a neighboring entity/role. To identify a neighboring entity or role, the threat detection system examines the cloud environment configuration (e.g., queries a cloud environment API to request metadata or configuration data) corresponding to the entity or role. Operational flow returns to block 305 to update the graph accordingly. The example operations present a simple sequence to explain the technology, but the discovery of potential attack paths can be more complex, for example involving recursion. The reverse discovery of potential attack paths from crown jewel asset nodes can have branches.

At block 309, the threat detection system adds a node for the principal and edge for an action that associates the principal with the entity/role. The node being added is added as a source node for the potential attack path. The edge can be labeled with an action to connect the principal node to a role node depending on whether the principal grants, assumes, or assigns the role. If the entity being connected to the principal node is an asset, then the edge connecting the nodes will be labeled with an action, such as connected or instantiated. For instance, a principal node that is a compute instance may connect to another compute instance node with an edge for the action of connecting to the compute instance with secure shell (SSH).

At block 311, the threat detection system determines combinations of permissions that create potential attack paths based on attack path heuristics and add synthetic nodes and edges accordingly. The threat detection system will identify the relevant entities or roles and add the synthetic edges and nodes based on the attack path heuristics. For instance, attack path heuristics specify that the combination of passing a role and running a compute instance allows for privilege escalation. Thus, the threat detection system would add an edge between a compute instance with an edge labeled for the combination of the pass role and run instance permissions.

At block 313, the threat detection system determines whether there is another crown jewel asset to indicate in the graph being built. If there is another crown jewel asset to process, then operational flow returns to block 301. Otherwise, operational flow ends. However, the set of operations for building and updating blast radius graphs will recur as depicted in FIG. 2.

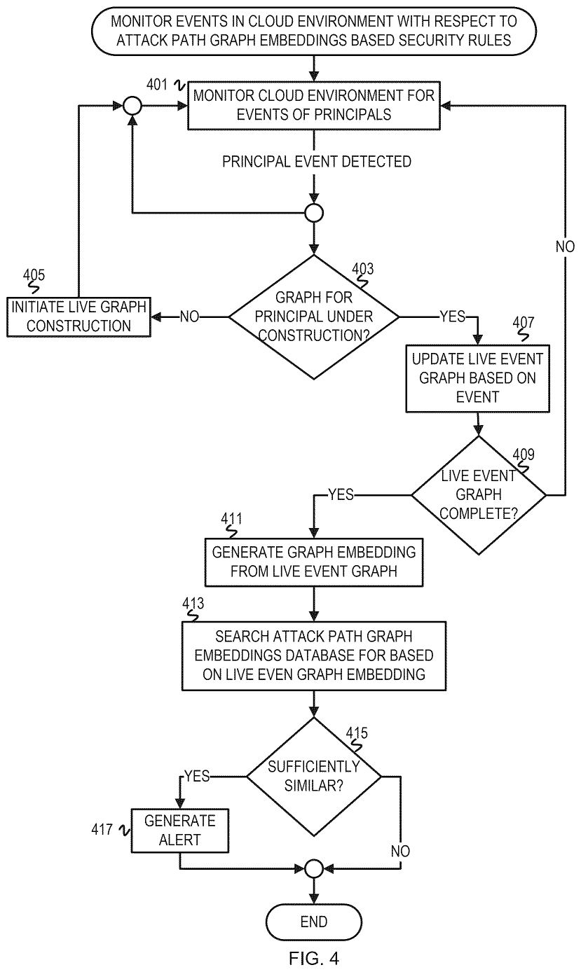

FIG. 4 is a flowchart of example operations for monitoring events in a cloud environment with respect to attack path graph embeddings-based security rules. The threat detection system will monitor for events corresponding to principals that correspond to potential attack paths, build detected event graphs in-line or in real-time, and evaluate the live event graphs against the security rules that are based on the attack path graph embeddings.

At block 401, the threat detection system monitors a cloud environment for events of principals. The threat detection system can monitor logs and/or repositories of the cloud environment for events that correspond to a user or service/process that can have a role and/or take actions on other resources of the cloud environment. The monitoring is ongoing as represented by the depiction of operational flow returning to block 401 and continuing to block 403. When an event indicating a principal is detected, then operational flow continues to block 403 while the monitoring also continues.

At block 403, the threat detection system determines whether a graph for the indicated principal is already under construction. The threat detection system can index or tag live event graphs with the principal identifiers. If a corresponding live event graph is already under construction, then operational flow proceeds to block 407. Otherwise, operational flow proceeds to block 405.

At block 405, the threat detection system initiates construction of a live event graph for the indicated principal. The threat detection system will generate a node that represents the principal and a node representing the entity or role indicated in the event. The threat detection system then connects the nodes with an edge labeled with the action indicated in the event. The threat detection system can parse the event based on keys or field names identifying the principal, target (entity), and action. The threat detection system can also use regular expression or pattern matching to identify these components. Operational flow returns to block 401 from block 405.

At block 407, the threat detection system updates the under construction live event graph based on the event. The threat detection system will examine or parse the event and add an edge and node to the under-construction graph based on the entity and action indicated in the event.

At block 409, the threat detection system determines whether the live event graph is complete. A completion or halting criterion is configured based on previously determined sufficient path length for informative similarity determination, such as 3 hops. Another criterion is that an event indicates a crown jewel asset. If the live event graph is complete, then operational flow proceeds to block 411. Otherwise, monitoring continues at block 401.

At block 411, the threat detection system generates a graph embedding of the live event graph. The threat detection system invokes the trained graph embedding model used to generate the attack path graph embeddings.

At block 413, the threat detection system searches the database of attack path graph embeddings. The threat detection, for instance, submits a search query that references or passes the live event graph embedding.

At block 415, the threat detection system determines whether a sufficiently similar attack path graph embedding was found. Similarity measurement will depend on the search algorithm and/or graph embedding technology being used, such as cosine similarity. A threshold is defined to delineate sufficient similarity. If there is sufficient similarity, then operational flow proceeds to block 417. Otherwise, operational flow ends for the analysis of the live event graph embedding while the monitoring continues. Embodiments can discard the live event graph or preserve the live event graph for historical analysis.

At block 417, the threat detection system generates an alert. The alert can identify the principal and crown jewel asset. In addition, the alert can reference a visualization of both the live event graph and the attack path that was found to be sufficiently similar. To allow references to the source attack paths, implementations can maintain mappings between the attack path graph embeddings and the attack paths.

### Variations

Embodiments can combine the attack path graph embeddings-based monitoring with attack path matching. Although less flexible, patterns or regular expressions can be maintained for potential attack paths and used for matching against sequences of live events. Embodiments can define a maximum path length for pattern-based path matching for efficiency. The two different detection techniques can be used together for validation or confidence evaluation. Implementations can use the pattern-based matching for short potential attack paths and embeddings for longer potential attack paths, with short and long defined by a configurable value.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

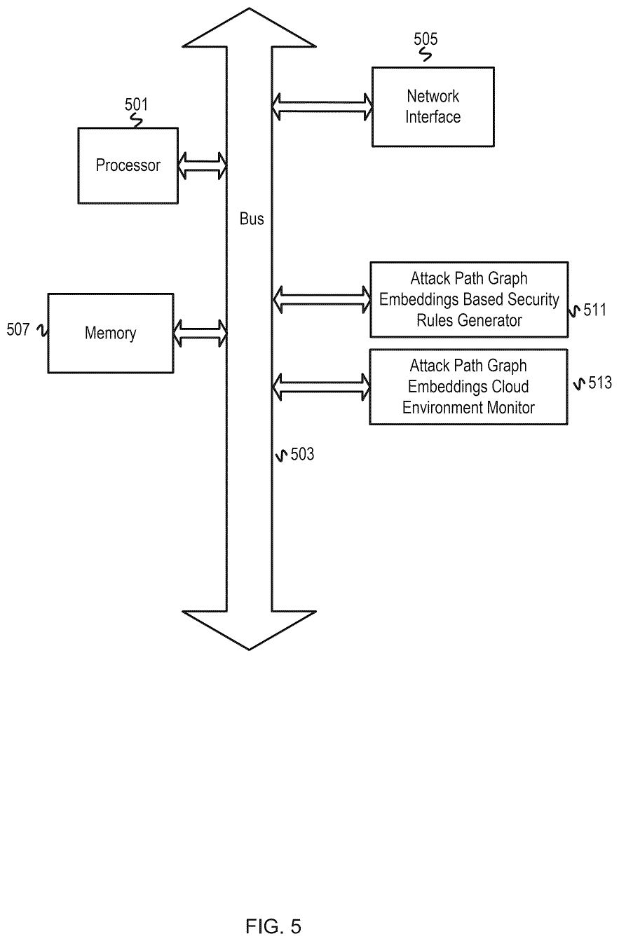

FIG. 5 depicts an example computer system with components of a threat detection system that detects threats based on attack path graph embeddings. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes an attack path graph embeddings-based security rules generator 511 (“rules generator”) and an attack path graph embeddings cloud environment monitor 513 (“monitor”). For FIG. 5, the previously described threat detection system has been logically modularized into the rule generator 511 and the monitor 513. The rule generator 511 uses attack path graph embeddings as basis for a security rule(s) for threat detection. This allows threat detection without a stringent path matching. The rules generator 511 determines potential attack paths to crown jewel assets of an organization and builds graph representations of the potential attack paths. The rules generator 511 generates graph embeddings from the graph representations. The rules generator 511 repeatedly updates the graph embeddings of potential attack paths based on repeatedly examining a cloud environment for relevant changes. The monitor 513 monitors in-line (with respect to the cloud environment and initiators of the events) or in real-time (i.e., monitors an active cloud environment) the cloud environment for events that indicate principals that are potential initiators of attacks, such as users or services. The monitor 513 constructs graphs or paths based on the monitoring and evaluates a constructed path/graph (“live event graph”) after a halting condition is satisfied. Evaluation involves the generation of a graph embedding from the live event graph and searching the attack path graph embeddings. A security action can be taken if a sufficiently similar attack path graph embedding is found. The security action can be generating an alert, blocking requests, locking an account, isolating a user, reducing permissions, etc. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
building and maintaining blast radius graphs for crown jewel assets of an organization;
generating graph embeddings of potential attack paths to the crown jewel assets, wherein generating the graph embeddings of potential attack paths comprises,
for each blast radius graph, extracting paths and generating a graph embedding for each extracted path; and
monitoring events for attacks, wherein monitoring the events comprises,
generating a graph of detected events based on at least one of the detected events indicating a principal and generating a graph embedding of the graph; and
determining whether an embedding of the graph of detected events is sufficiently similar to one of the attack path graph embeddings; and
generating an alert if the embedding of the graph of detected events is sufficiently similar to an attack path graph embedding.

2. The method of claim 1, wherein extracting subgraphs comprises at least one of:
extracting each path in each blast radius graph from a source node to each reachable node representing one of the crown jewel assets;
extracting all possible paths through each blast radius graph;
randomly extracting paths in each blast radius graph; and
identifying nodes in each blast radius graph having an identified risk and extracting a path that includes the identified risky node.

3. The method of claim 1 further comprising training a graph embeddings model on the blast radius graphs and retraining the graph embeddings model after each update of the blast radius graphs, wherein maintaining the blast radius graphs comprises updating the blast radius graphs and generating the attack path graph embeddings is with the trained graph embedding model.

4. The method of claim 1, wherein building the blast radius graph comprises:
identifying the crown jewel assets and adding nodes to represent the crown jewel assets;
determining roles with permissions to access the crown jewel assets and adding edges representing those roles; and
identifying entities that can assume the determined roles and adding nodes representing the entities and connecting those nodes to the edges according to the roles.

5. The method of claim 4, wherein building the blast radius graph further comprises:
adding edges and nodes representing combinations of at least one of roles and permissions that allow privilege escalation or lateral movement, wherein the combinations are indicated by heuristics.

6. The method of claim 4, wherein an entity is an asset, a service, or a principal.

7. The method of claim 1, wherein maintaining the blast radius graph comprises updating the blast radius graph periodically and/or updating the blast radius graph based on detection of a change in at least one of crown jewel assets, permissions, and roles.

8. The method of claim 1 further comprising:
storing each subgraph extracted from the blast radius graphs,
wherein monitoring the events further comprises determining whether a graph of detected events matches one of the extracted paths.

9. A non-transitory, machine-readable medium having stored thereon program code comprising instructions to:
periodically build blast radius graphs for crown jewel assets of an organization; and
generate graph embeddings of potential attack paths to the crown jewel assets based on the current blast radius graphs, wherein the instructions to generate the graph embeddings of potential attack paths comprise instructions to, select subgraphs from the blast radius graphs and generate graph embeddings from the selected subgraphs; and
monitor events in a cloud environment using the graph embeddings, wherein the instructions to monitor the events comprise instructions to,
generate a graph of detected events based on detection of an event corresponding to an entity in the cloud environment that can take an action or have a role and generate an embedding of the graph; and
determine whether an embedding of the graph of detected events is sufficiently similar to one of the attack path graph embeddings; and
generate an alert if the embedding of the graph of detected events is sufficiently similar to an attack path graph embedding.

10. The non-transitory, machine-readable medium of claim 9, wherein the instructions to select subgraphs comprise at least one of:
instructions to select each path in each blast radius graph from a source node to each reachable node representing one of the crown jewel assets;
instructions to select all possible paths through each blast radius graph;
instructions to randomly select paths in each blast radius graph; and
instructions to identify nodes in each blast radius graph having an identified risk and extract a path that includes the identified risky node.

11. The non-transitory, machine-readable medium of claim 9, wherein the program code further comprises instructions to train a graph embeddings model on the blast radius graphs when initially constructed and retrain the graph embeddings model after each update of the blast radius graphs, wherein the instructions to maintain current blast radius graphs comprise instructions to update the blast radius graphs periodically and/or in response to an event of the cloud environment.

12. The non-transitory, machine-readable medium of claim 9, wherein the instructions to periodically build blast radius graphs comprise instructions to:
identify the crown jewel assets and add nodes to represent the crown jewel assets;
determine roles with permissions to access the crown jewel assets and add edges representing those roles;
identify entities that can assume the determined roles and add nodes representing the entities and connect those nodes to the edges according to the roles; and
add edges and nodes representing combinations of at least one of roles and permissions that allow privilege escalation or lateral movement, wherein the combinations are indicated by heuristics.

13. The non-transitory, machine-readable medium of claim 12, wherein an entity is an asset, a service, or a principal.

14. The non-transitory, machine-readable medium of claim 9, wherein program code further comprise instructions to update or build blast radius graphs based on detection of a change in at least one of crown jewel assets, permissions, and roles.

15. The non-transitory, machine-readable medium of claim 9, wherein the program code further comprises instructions to:
store each subgraph selected from the blast radius graphs,
wherein the instructions to monitor the events further comprise instructions to determine whether a graph of detected events matches one of the selected subgraph paths.

16. An apparatus comprising:
a processor; and
a machine-readable medium having stored thereon instructions executable by the processor to cause the apparatus to,
build blast radius graphs for crown jewel assets of an organization; and
generate graph embeddings of potential attack paths to the crown jewel assets based on the current blast radius graphs, wherein the instructions to generate the graph embeddings of potential attack paths comprise instructions to,
select subgraphs from the blast radius graphs and generate graph embeddings from the selected subgraphs; and
monitor events in a cloud environment using the graph embeddings, wherein the instructions to monitor the events comprise instructions to,
generate a graph of detected events based on detection of an event corresponding to an entity in the cloud environment that can take an action or have a role and generate an embedding of the graph; and
determine whether an embedding of the graph of detected events is sufficiently similar to one of the attack path graph embeddings; and
generate an alert if the embedding of the graph of detected events is sufficiently similar to an attack path graph embedding.

17. The apparatus of claim 16, wherein the instructions to select subgraphs comprise at least one of:
instructions executable by the processor to cause the apparatus to select each path in each blast radius graph from a source node to each reachable node representing one of the crown jewel assets;
instructions executable by the processor to cause the apparatus to select all possible paths through each blast radius graph;
instructions executable by the processor to cause the apparatus to randomly select subgraphs in each blast radius graph; and
instructions executable by the processor to cause the apparatus to identify nodes in each blast radius graph having an identified risk and extract a path that includes the identified risky node.

18. The apparatus of claim 16, wherein the instructions to build blast radius graphs comprise instructions executable by the processor to cause the apparatus to periodically rebuild blast radius graphs and/or update the blast radius graphs based on detection of a change in at least one of crown jewel assets, permissions, and roles.

19. The apparatus of claim 17, wherein the program code further comprises instructions to train a graph embeddings model on the blast radius graphs when initially constructed and retrain the graph embeddings model after each build or update of the blast radius graphs.

20. The apparatus of claim 16, wherein the instructions to build blast radius graphs comprise instructions executable by the processor to cause the apparatus to:
identify the crown jewel assets and add nodes to represent the crown jewel assets;
determine roles with permissions to access the crown jewel assets and add edges representing those roles;
identify entities that can assume the determined roles and add nodes representing the entities and connect those nodes to the edges according to the roles; and
add edges and nodes representing combinations of at least one of roles and permissions that allow privilege escalation or lateral movement, wherein the combinations are indicated by heuristics,
wherein an entity is an asset, a service, or a principal.
